(19) United States
(12) Patent Application Publication
(10) Pub. No.: US 2003/0019099 A1
(43) Pub. Date: Jan. 30, 2003

(54) Electric cable splicing system and method

(76) Inventors: Robert D. Carter, Orlando, FL (US); Clayton R. Hiers, Orlando, FL (US)

Correspondence Address: Edward M. Livingston, Esq., 628 Ellen Dr., P.O. Box 1599, Winter Park, FL, 32790, US

(21) Appl. No.: 09/906,546

(22) Filed: Jul. 16, 2001

(51) Int. Cl. H01R 43/00

(52) U.S. Cl. 29/868; 29/755

(57) ABSTRACT

An electric-cable-splicing system and method has a bidirectional jack that includes a bidirectional actuator (6,16,18) on a jack rod (9). Cable collars (11, 15, 17) and jacket collars (10) can be positioned as advantageous and convenient for holding cable (3) and for positioning cable jackets (13) on the cable while the cable is being spliced or joined. The cable collars can be sized and positioned on the jack rod as needed for particular cable-working requirements. The jacket collars are movable bidirectionally on the jack rod with the bidirectional jack. The bidirectional jack slides tight-fitting cable jackets onto cables in a first direction before cable splices (14) and joints are made. After the splices and joints are made, the bidirectional jack then slides the tight-fitting cable jackets oppositely in a second direction to a covering position of linearly overlapping and circumferentially surrounding the splices or joints. Sealant can be added to surfaces of the cable and the cable jackets selectively. One or more of the bidirectional jacks can be positioned on the jack rod and provided with jacket collars and cable collars selectively.

### BACKGROUND OF THE INVENTION

This invention relates to splicing electric cable for repair and end joining.

Dangerous, difficult and time-consuming work is required to repair, splice and join underground cables that frequently get damaged by construction and various excavation activities, as well as deteriation due to age. Currently, coverings known as jackets, also called “boots” are placed over a splice. Much hazardous manual labor is required. There are known splicing devices and methods, but none with convenient, fast and safe bidirectional cable positioning and jacket covering in a manner taught by this invention.

Examples of most-closely related known but different devices are described in U.S. Pat. No. 3,712,588, issued to Coil on Jan. 23, 1973; U.S. Pat. No. 5,687,955 issued to Bonser, et al. on Nov. 18, 1997; U.S. Pat. No. 4,223,436 issued to Silva on Sep. 23, 1980; Denmark Patent No. DEN 29066 issued on Dec. 13, 1921; U.S. Pat. No. 4,661,662issued to Finke, et al. on Apr. 28, 1987; U.S. Pat. No. 3,164,373 issued to Hudzinski on Jan. 5, 1965; U.S. Pat. No. 3,311,348 issued to Taylor on Mar. 28, 1967; and U.S. Pat. No. 3,591,140 issued to McCoy on Jul. 6, 1971.

### SUMMARY OF THE INVENTION

Objects of patentable novelty and utility taught by this invention are to provide an electric-cable-splicing system and method which:

positions cable conveniently while being trimmed and spliced;

slides tight-fitting sleeves or jackets onto cable and into sealing positions over splices and end joints;

is cable-size adaptable;

fits into relatively smaller working spaces of holes dug for cable repair;

has cable-axis operation of mechanical features that avoid twist and rotation of cables; and

is adaptable to safety procedures and devices.

This invention accomplishes these and other objectives with an electric-cable-splicing system and method having a bidirectional jack with a jack rod on which cable collars and cable-jacket collars can be positioned as advantageous and convenient for holding cable and for positioning cable jackets on the cable while the cable is being spliced or joined. The cable collars can be sized and positioned on the jack rod as needed for particular cable-working requirements. The cable-jacket collars are movable bidirectionally on the jack rod with the bidirectional jack. The bidirectional jack slides tight-fitting cable jackets onto cables in a first direction before splices and joints are prepared. After the splices and joints are prepared, the bidirectional jack then slides the tight-fitting cable jackets oppositely in a second direction to a covering position of linearly overlapping and circumferentially surrounding the splices or joints. Sealant can be added to surfaces of the cable and the cable jackets selectively. One or more of the bidirectional jacks can be positioned on the jack rod and provided with cable-jacket collars and cable collars selectively.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a side view of a first end and a second end of a cable that has been prepared for splicing;

FIG. 2 is a side view of a bidirectional jack having a bidirectional actuator with a jacket collar attached to a cable jacket in a temporary position proximate a cable-collar position at which a cable collar on a first end of a jack rod is attached to a first end of a cable to be spliced;

FIG. 3 is the FIG. 2 illustration with a cable splice joining the first end and the second end of the cable;

FIG. 4 is the FIG. 3 illustration with the cable jacket slid over the cable splice by actuating the bidirectional jack in a direction of the second end of the cable;

FIG. 5 is a side view of a cable being held for cable splicing by a bidirectional jack with a cable collar attached to the cable-collar position proximate the first end of the cable and a cable collar on a bidirectional actuator having two actuator levers attached to the second end of the cable while the cable is being prepared for splicing and while another of the bidirectional actuators with an open jacket collar is positioned on the jack rod;

FIG. 6 is the FIG. 5 illustration with a cable jacket in the jacket collar slid to a temporary position and with a cable splice joining the first end and the second end of the cable;

FIG. 7 is the FIG. 6 illustration with the cable jacket slid over the cable splice by actuating the bidirectional jack in a direction of the second end of the cable;

FIG. 8 is a partially cutaway side view of a bidirectional actuator having two actuator levers that pivot on lever axles on an actuator housing that is actuated to slide on a jack rod having a plurality of bidirectional actuator buttresses;

FIG. 9 is a partially cutaway end view of a jack rod that is a rectangular tube having bidirectional actuator buttresses that are walls of indentations in a side of the jack rod;

FIG. 10 is a top view of a portion of the jack rod shown in FIGS. 8-9, 11 and 13-14;

FIG. 11 is a partially cutaway side view of a bidirectional actuator that is a single-lever actuator in a single-lever housing that is slidable linearly on the jack rod with first and second latches and a bidirectional stop latch on a single lever;

FIG. 12 is the FIG. 7 illustration modified to show use of single-lever actuators as an option to bidirectional actuators having two actuator levers for a method to use this cable-splicing system;

FIG. 13 is the FIG. 8 illustration showing use of a wire spring as an option to leaf springs;

FIG. 14 is the FIG. 11 illustration showing use of a bidirectional actuator latch as an option to first and second latches;

FIG. 15 is a top view of the FIG. 14 illustration;

FIG. 16 is a partially cutaway side view of a portion of a jack rod having orthogonal sides in a cross wall of a channel rod; and

FIG. 17 is an end view of the jack rod shown in FIG. 16.

### DESCRIPTION OF PREFERRED EMBODIMENT

Listed numerically below with reference to the drawings are terms used to describe features of this invention. These terms and numbers assigned to them designate the same features throughout this description.

```
  1. First joint end
  2. Second joint end
  3. Cable
  4. Insulated core
  5. Outside barrier
  6. Bidirectional actuator
  7. First end of jack rod
  8. Second end of jack rod
  9. Jack rod
10. Jacket collar
11. Cable collar
12. Cable-collar position
13. Cable jacket
14. Cable splice
15. First cable collar
16. First bidirectional actuator
17. Second cable collar
18. Second bidirectional actuator
19. Polygonal tube
20. Walls
21. Indentations
22. Actuator housing
23. Slide walls
24. Slide rollers
25. First actuator lever
26. First lever axle
27. Second actuator lever
28. Second lever axle
29. Handle connections
30. First-direction stop latch
31. First-stop pivot end
32. First-stop buttress end
33. Second-direction stop latch
34. Second-stop pivot end
35. Second-stop buttress end
36. First-direction actuation latch
37. First-actuation pivot end
38. First lever position
39. First-actuation buttress end
40. Second-direction actuation latch
41. Second-actuation pivot end
42. Second lever position
43. Second-actuation buttress end
44. First stop spring
45. First actuator spring
46. Second stop spring
47. Second actuator spring
48. Single-lever housing
49. Bidirectional lever
50. Single-lever axle
51. Bidirectional stop latch
52. First end of bidirectional stop latch
53. Second end of bidirectional stop latch
54. First latch
55. First latch axle
56. Buttress end of first latch
57. Second latch
58. Second latch axle
59. Buttress end of second latch
60. First stop spring
61. Second stop spring
62. First latch spring
63. Spring base
64. Second latch spring
65. Bidirectional actuator latch
66. Central actuator axle
67. First buttress end
68. Bidirectional actuator
69. Second buttress end
70. Bidirectional actuation spring
71. Direction-control member
72. Direction-control knob
73. First wire ratchet spring
74. First regulator bolt
75. First regulator slot
76. First regulator knob
77. Second wire ratchet spring
78. Second regulator bolt
79. Second regulator slot
80. Second regulator knob
```

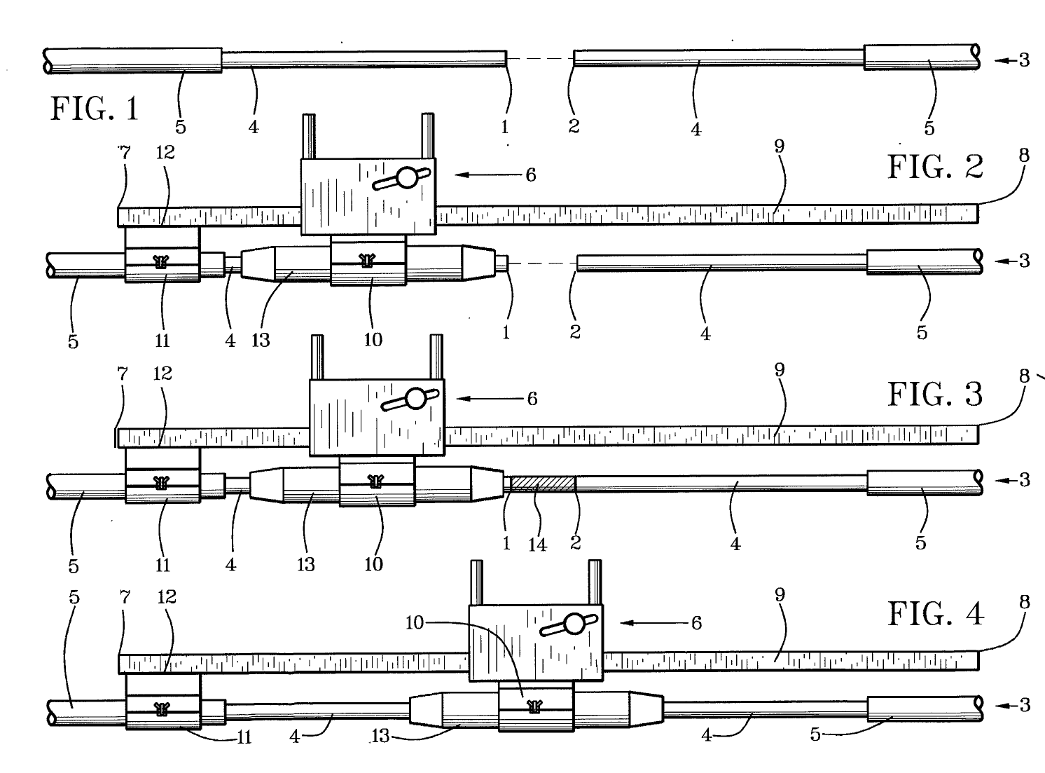

Referring to FIGS. 1-4, a cable-splicing system and method includes splicing or otherwise joining a first joint end 1 to a second joint end 2 of a cable 3 which includes a high-power electrical cable that generally is positioned centrally in an insulated core 4 which is encompassed circumferentially by an outside barrier 5 that usually contains conductor wires to ground out or otherwise deflect exterior current from lightning and other cables or sources of interference current.

One embodiment of the cable-splicing system has a bidirectional jack with a bidirectional actuator 6 that is actuated bidirectionally intermediate a first end 7 and a second end 8 of a jack rod 9. The bidirectional actuator 6 includes a jacket collar 10. A cable collar 11 is attached to the jack rod 9 at a desired position proximate the first end 7 of the jack rod 9. The jacket collar 10 and the cable collar 11 are side-loadable.

A method for using this embodiment includes the steps of:

preparing a first joint end 1 and a second joint end 2 of the cable 3 to be spliced;

attaching the cable collar 11 to the cable 3 at a cable-collar position 2 on the cable 3 that is a sufficient distance from the first joint end 1 of the cable 3 to allow temporary positioning of a cable jacket 13 intermediate a cable splice 14 and the cable-collar position 12;

attaching the jacket collar 10 to the cable jacket 13;

positioning a first end of the cable jacket 13 for receiving the first joint end 1 of the cable 3 into a circumferential internal periphery of the cable jacket 13;

actuating the bidirectional actuator 6 in a first direction that is towards the cable-collar position 12 for sliding the first joint end 1 of the cable 3 a sufficient distance through the cable jacket 13 to expose the first joint end 1 of the cable 3 for being spliced to the second joint end 2 of the cable 3;

splicing the first joint end 1 to the second joint end 2 of the cable 3 with the cable splice 14;

actuating the bidirectional actuator 6 in a second direction that is away from the cable-collar position 12 for sliding the cable jacket 13 from the temporary position to a splice-sealing position on the cable splice 14; and

removing the bidirectional jack by removing the jacket collar 10 from the cable jacket 13 and removing the cable collar 11 from the first joint end 1 of the cable 3.

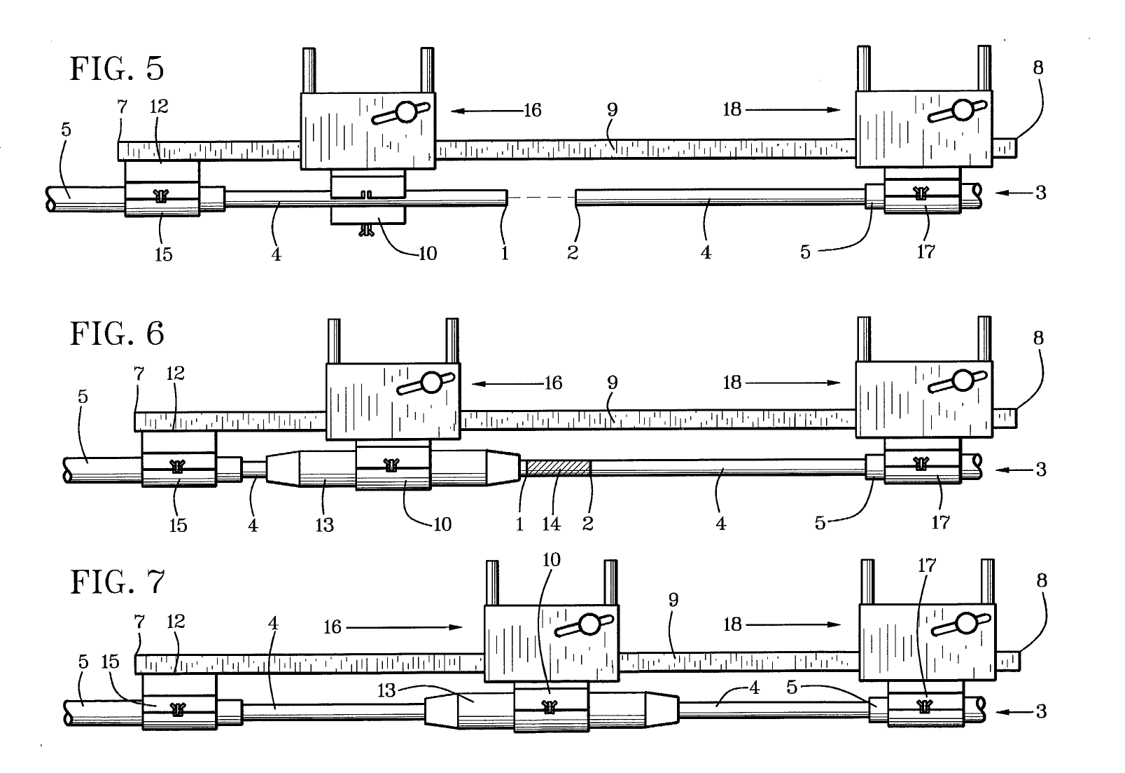

Referring to FIGS. 5-7 and 12, another embodiment of the cable-splicing system has a bidirectional jack with one or more bidirectional actuators that are actuated bidirectionally intermediate the first end 7 and the second end 8 of the jack rod 9. A first cable collar 15 is attached to the jack rod 9 proximate the first end 7 of the jack rod 9 at a desired cable-collar position 12 that is proximate the first joint end 1 of the cable 3 to be spliced. The jacket collar 10 is on a first bidirectional actuator 16 and a second cable collar 17 is on a second bidirectional actuator 18

A method for using this embodiment includes the steps of:

attaching the first cable collar 15 to the first joint end 1 of a cable 3 to be spliced;

attaching the second cable collar 17 to the second joint end 2 of the cable 3;

actuating the second bidirectional actuator 18 selectively for the cable 3 to be held as desired intermediate the first cable collar 15 and the second cable collar 17;

preparing the cable 3 for splicing intermediate the first cable collar 15 and the second cable collar 17;

attaching a cable jacket 13 to the jacket collar 10;

positioning the first joint end 1 of the cable 3 for entry into the cable jacket 13;

actuating the first bidirectional actuator 16 in a first direction towards the cable-collar position 12 for sliding the first joint end 1 of the cable 3 into the cable jacket 13 and for sliding the first joint end 1 a sufficient distance through the cable jacket 13 to place the cable jacket 13 at a temporary position intermediate the first joint end 1 of the cable 3 and the cable-collar position 12;

splicing the first joint end 1 to the second joint end 2 of the cable 3 with the cable splice 14;

actuating the first bidirectional actuator 16 in a second direction away from the cable-collar position 12 for sliding the cable jacket 13 from the temporary position in a direction towards the second joint end 2 to a splice-sealing position that covers the cable splice 14; and

removing the bidirectional jack by removing the jacket collar 10 from the cable jacket 13, removing the first cable collar 15 from the first joint end 1 and removing the second cable collar 17 from the second joint end 2 of the cable 3.

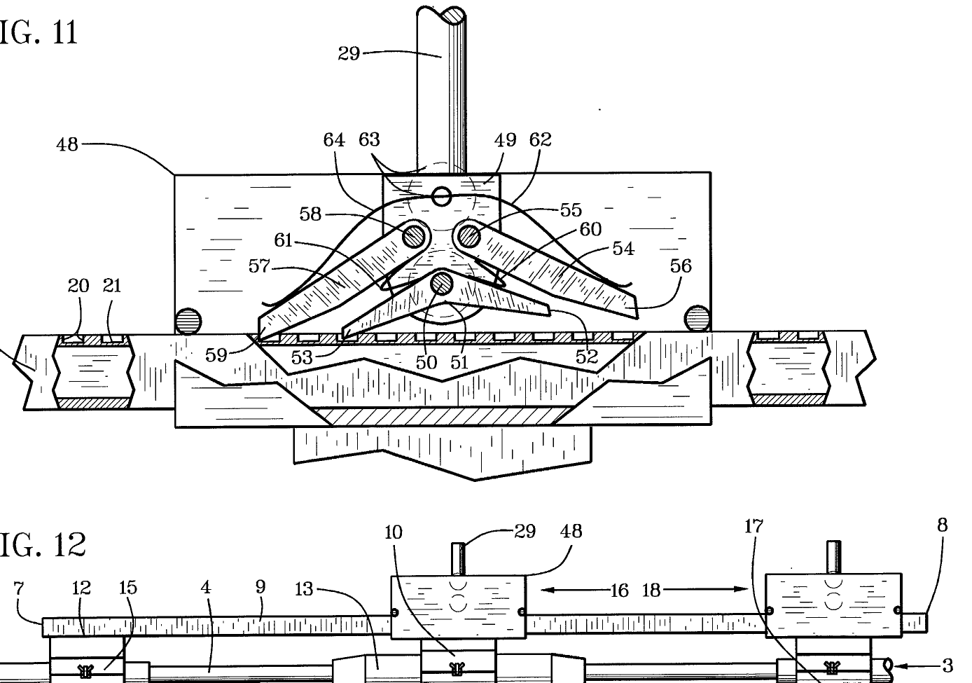

Referring to FIGS. 1-6 and 8-10, the jack rod 9 on which the bidirectional actuator 6 has bidirectional actuation includes a plurality of bidirectional actuator buttresses juxtaposed in series linearly on an outside periphery of the jack rod 9. The jack rod 9 can include a polygonal tube 19 and the plurality of bidirectional actuator buttresses can be walls 20 of indentations 21 that preferably are elongate in an outside periphery of the jack rod 9.

For a two-lever embodiment, the bidirectional actuator 6 has an actuator housing 22 that is slidable linearly on the jack rod 9 in contact preferably with slide walls 23 and slide rollers 24.

A first actuator lever 25 is pivotal on a first lever axle 26 proximate a first end of the actuator housing 22. A second actuator lever 27 is pivotal on a second lever axle 28 proximate a second end of the actuator housing 22. Handle connections 29 can be extended from the first actuator lever 25 and from the second actuator lever 27.

A first-direction stop latch 30 has a first-stop pivot end 31 attached pivotally to the first lever axle 26. The first-direction stop latch 30 has a first-stop buttress end 32 extended pivotally to engage first sides of the bidirectional actuator buttresses, which include the walls 20 of indentations 21, one actuator buttress at a time. A second-direction stop latch 33 has a second-stop pivot end 34 attached pivotally to the second lever axle 28. The second-direction stop latch 33 has a second-stop buttress end 35 extended pivotally to engage second sides of the bidirectional actuator buttresses, which include the walls 20 of indentations 21, one actuator buttress at a time.

A first-direction actuation latch 36 has a first-actuation pivot end 37 attached pivotally to the first actuator lever 25 at a first lever position 38 that is outwardly from the first lever axle 26. The first-direction actuation latch 36 has a first-actuation buttress end 39 extended pivotally from the first actuator lever 25 to engage the bidirectional actuator buttresses, which include the walls 20 of indentations 21, one actuator buttress at a time. A second-direction actuation latch 40 has a second-actuation pivot end 41 attached pivotally to the second actuator lever 27 at a second lever position 42 that is outwardly from the second lever axle 28. The second-direction actuation latch 40 has a second-actuation buttress end 43 extended pivotally from the second actuator lever 27 to engage the bidirectional actuator buttresses, which include the walls 20 of indentations 21, one actuator buttress at a time.

The first-direction stop latch 30 faces the second-direction stop latch 33 and the first-direction actuator latch 36 faces the second-direction actuator latch 40.

A first stop spring 44 has push-expansion pressure applied intermediate the first-directional stop latch 30 and the first-direction actuation latch 36 for actuating the first-direction stop latch 30 in a direction of the bidirectional actuator buttresses one actuator buttress at a time. A first actuator spring 45 has push-expansion pressure applied intermediate the first actuator lever 25 and the first-direction actuation latch 36 for actuating the first-direction actuator latch 36 in a direction of the bidirectional actuator buttresses one actuator buttress at a time.

A second stop spring 46 has push-expansion pressure applied intermediate the second-directional stop latch 33 and the second-direction actuation latch 40 for actuating the second-direction stop latch 33 in a direction of the bidirectional actuator buttresses one actuator buttress at a time. A second actuator spring 47 has push-expansion pressure applied intermediate the second actuator lever 27 and the second-direction actuation latch 40 for actuating the second-direction actuator latch 40 in a direction of the bidirectional actuator buttresses one actuator buttress at a time.

Referring to FIGS. 11-12, each of a plurality or one of the bidirectional actuators can be single-lever actuators having a single-lever housing 48 that is slidable linearly on the jack rod 9. Each of the single-lever actuators has a bidirectional lever 49 that is pivotal on a single-lever axle 50 on the single-lever housing 48. A bidirectional stop latch 51 also is pivotal on the single-lever axle 50. The bidirectional stop latch 51 has a first end 52 that engages the bidirectional actuator buttresses one buttress at a time on a first side of the single-lever axle 50 for stopping second-direction travel of the bidirectional actuator on the jack rod 9. The bidirectional stop latch 51 has a second end 53 that engages the bidirectional actuator buttresses one buttress at a time on a second side of the single-lever axle 50 for stopping first-direction travel of the bidirectional actuator on the jack rod 9.

A first latch 54 on the first side of the bidirectional lever 49 has a lever end attached pivotally to a first latch axle 55 on the first side of the bidirectional lever 49. The first latch 54 has a buttress end 56 that engages the bidirectional actuator buttresses one buttress at a time on the first side of the single-lever axle 50 for actuating the bidirectional actuator in a first direction by pivoting the bidirectional lever oppositely in the second direction from the single-lever axle 50 selectively.

A second latch 57 on the second side of the bidirectional lever 49 has a lever end attached pivotally to a second latch axle 58 on the second side of the bidirectional lever 49. The second latch 57 has a buttress end 59 that engages the bidirectional actuator buttresses one buttress at a time on the second side of the single-lever axle 50 for actuating the bidirectional actuator in a second direction by pivoting the bidirectional lever oppositely in the first direction from the single-lever axle 50 selectively.

A first stop spring 60 has push-expansion pressure applied intermediate the first end 52 of the bidirectional stop latch 51 and the first latch 54. A second stop spring 61 has push-expansion pressure applied intermediate the second end 53 of the bidirectional stop latch 51 and the second latch 57.

A first latch spring 62 has push-expansion pressure applied intermediate the first latch 54 and a spring base 63 that is outwardly from the first latch spring 62 on the bidirectional lever 49. A second latch spring 64 has push-expansion pressure applied intermediate the second latch 57 and the spring base 63.

The push-expansion pressure on the first latch spring 62 and the push-expansion pressure on the second latch spring 64 are adjustable with the spring base 63. The push-expansion pressure on the first latch spring 62 being increased and the push-expansion pressure on the second latch spring 64 being decreased for actuation of the bidirectional actuator in the first direction. The push-expansion pressure on the second latch spring 64 being increased and the push-expansion pressure on the first latch spring 62 being decreased for actuation of the bidirectional actuator in the second direction.

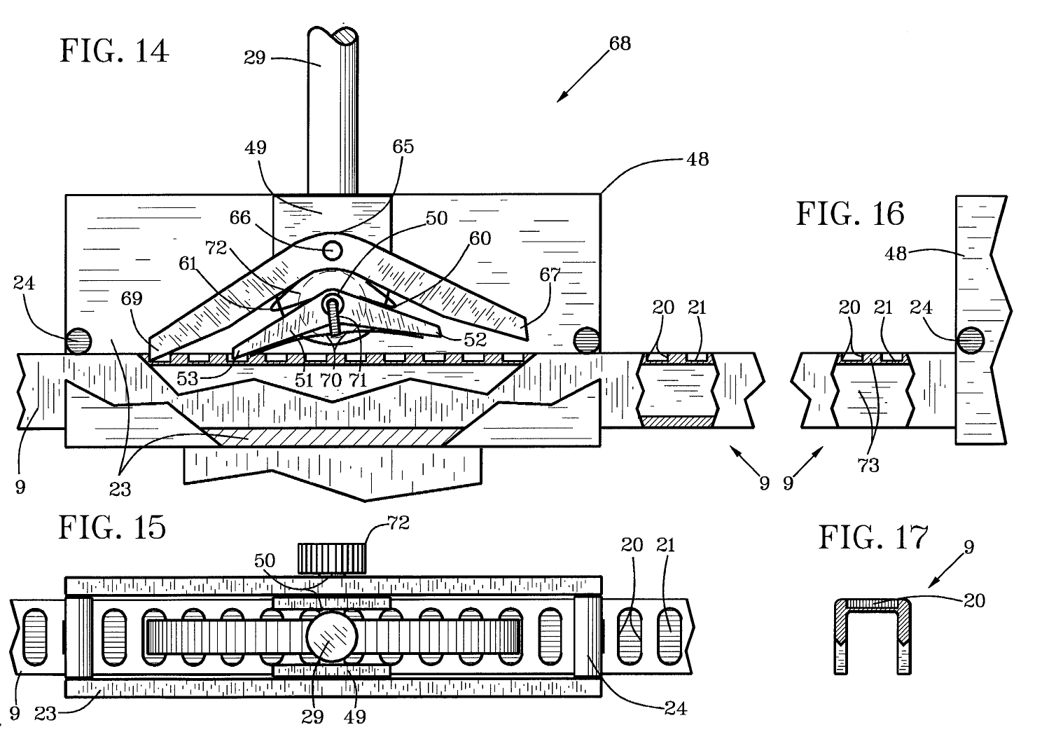

Referring to FIGS. 14-17, optionally different than described in relation to FIG. 11, a bidirectional actuator latch 65 is pivotal on a central actuator axle 66 outwardly from the single-lever axle 50 on the bidirectional lever 49. The bidirectional actuator latch 65 has a first buttress end 67 that engages the bidirectional actuator buttresses on the first side of the single-lever axle 50 for actuating a bidirectional actuator 68 in a first direction by pivoting the bidirectional lever 49 oppositely in the second direction from the single-lever axle 50 selectively. The bidirectional actuator latch 65 has a second buttress end 69 that engages the bidirectional actuator buttresses on the second side of the single-lever axle 50 for actuating the bidirectional actuator 68 in a second direction by pivoting the bidirectional lever 49 oppositely in the first direction from the single-lever axle 50 selectively.

A first stop spring 60 has push-expansion pressure applied intermediate the first end 52 of the bidirectional stop latch 51 and the first buttress end 67 of the bidirectional actuator latch 65. The second stop spring 61 has push-expansion pressure applied intermediate the second end 53 of the bidirectional stop latch 51 and the second buttress end 69 of the bidirectional actuator latch 65.

A bidirectional actuation spring 70 is attached to a direction-control member 71 extended from the single-lever axle 50. The bidirectional actuation spring 70 is bifurcated centrally from the direction-control member 71.

The direction-control member 71 is pivotal in a first direction to apply push-expansion pressure of a first leg of the bidirectional actuation spring 70 against the first end 52 of the bidirectional stop latch 51 and to remove the push-expansion pressure from the second leg of the bidirectional actuation spring 70 for actuating the bidirectional actuator 68 in the first direction from the single-lever axle 50 by pivoting the bidirectional lever 49 oppositely in the second direction from the single-lever axle 50.

The direction-control member 71 is pivotal in a second direction to apply push-expansion pressure of a second leg of the bidirectional actuation spring 70 against the second end of the bidirectional stop latch 51 and to remove the push-expansion pressure from the second leg of the bidirectional actuation spring 70 for actuating the bidirectional actuator 68 in the second direction from the single-lever axle 50 by pivoting the bidirectional lever 49 oppositely in the first direction from the single-lever axle 50.

The direction-control member 71 is attached to a direction-control knob 72 having controlled pivotal positioning.

The jack rod 9 can include orthogonal sides and the actuator buttresses can be the walls 20 of the indentations 21 in one of the sides of an outside periphery of the jack rod 9 that is channeled or otherwise orthogonal as shown in FIGS. 16-17.

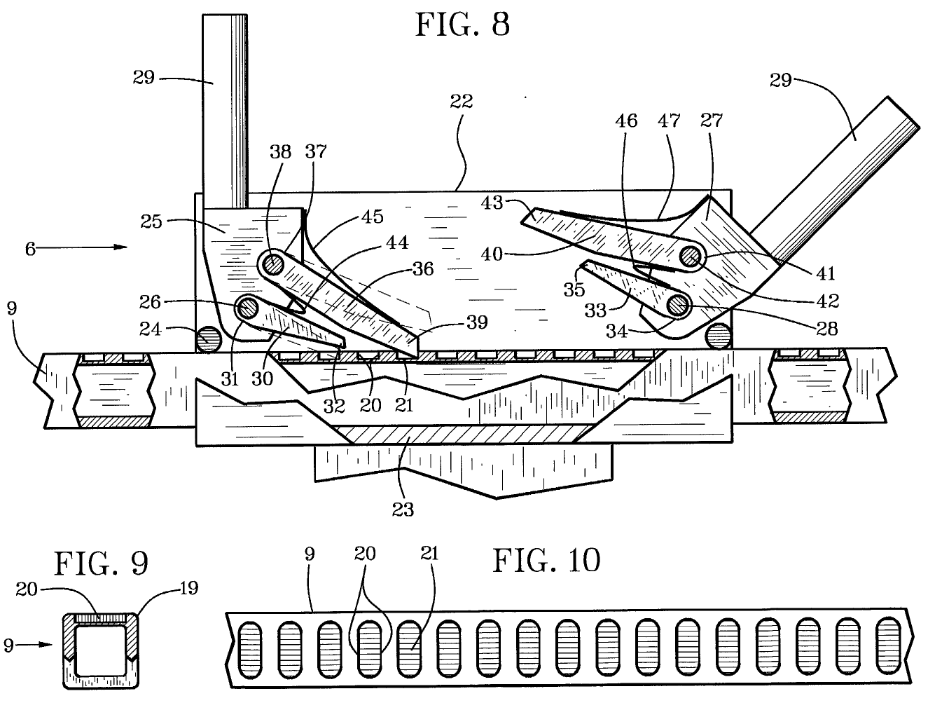

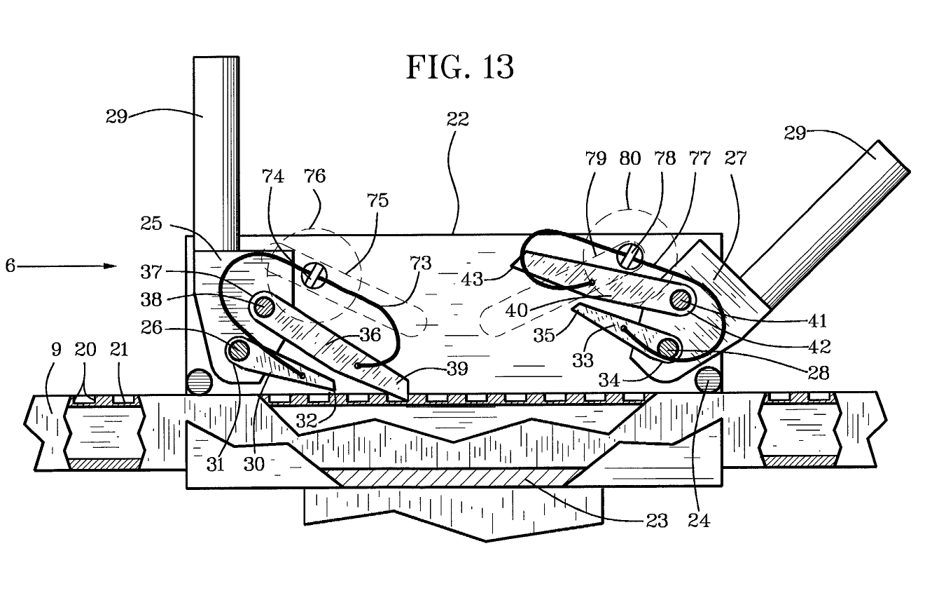

Referring to FIG. 13 and to FIG. 8 further, functions of the first stop spring 44 and the first actuator spring 45 shown and described in relation to FIG. 8 can be provided by a first wire ratchet spring 73 having a first end attached to the first-direction stop latch 30 and a second end attached to the first-direction actuation latch 36 as shown in FIG. 13. The first wire ratchet spring 73 is routed through a first regulator bolt 74 that is extended through a first regulator slot 75 in a first side of the actuator housing 22.

The first regulator bolt 74 has machine threading with which it is screwed into a first regulator knob 76. The first regulator slot 75 is angled for positioning the first regulator bolt 74 in order to position the first wire ratchet spring 73 therein predeterminedly near the walls 20 of the actuator buttresses for actuating ratchet engagement of the first-direction stop latch 30 and the first-direction actuation latch 36 predeterminedly removed from the actuator buttresses to prevent the ratchet engagement of the first-direction stop latch 30 and the first-direction actuation latch 36 with the walls 20 of the actuator buttresses selectively.

Correspondingly for an opposite direction of actuation, functions of the second stop spring 46 and the second actuator spring 47 shown and described in relation to FIG. 8 can be provided by a second wire ratchet spring 77 having a first end attached to the second-direction stop latch 33 and a second end attached to the second-direction actuation latch 40 as shown in FIG. 13. The second wire ratchet spring 77 is routed through a second regulator bolt 78 that is extended through a second regulator slot 79 in a second side of the actuator housing 22.

The second regulator bolt 78 has machine threading with which it is screwed into a second regulator knob 80. The second regulator slot 79 is angled for positioning the second regulator bolt 78 in order to position the second wire ratchet spring 77 therein predeterminedly near the walls 20 of the actuator buttresses for actuating ratchet engagement of the second-direction stop latch 33 and the second-direction actuation latch 40 predeterminedly removed from the actuator buttresses to prevent the ratchet engagement of the second-direction stop latch 33 and the second-direction actuation latch 40 with the walls 20 of the actuator buttresses selectively.

A new and useful electric-cable-splicing system and method having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A cable-splicing system comprising:
a bidirectional jack having a bidirectional actuator that is actuated bidirectionally on a jack rod;
a cable-jacket collar on the bidirectional actuator;
a cable collar attached to the jack rod in desired proximity to a first end of the jack rod;
the cable-jacket collar and the cable collar being on a cable-holding side of the jack rod; and
the bidirectional actuator being actuated bidirectionally to position the cable-jacket collar selectively intermediate the cable collar and a second end of the jack rod.

2. The cable-splicing system of claim 1 and further comprising:
a second bidirectional actuator that is actuated bidirectionally on the jack rod;
a second cable collar attached to the second bidirectional actuator;
the second cable collar being on the cable-holding side of the jack rod; and
the second bidirectional actuator being actuated bidirectionally intermediate the cable-jacket collar and the second end of the jack rod.

3. A cable-splicing system comprising:
a bidirectional jack with a jack rod on which a cable collar is positioned for holding cable while the cable is being spliced or joined and while a cable jacket is being positioned on the cable;
a bidirectional actuator having bidirectional actuation on the jack rod;
a plurality of bidirectional actuator buttresses juxtaposed in series linearly on an outside periphery of the jack rod;
the bidirectional actuator having an actuator housing that is slidable linearly on the jack rod;
a jacket collar attached to the bidirectional actuator;
a first actuator lever that is pivotal on a first lever axle proximate a first end of the actuator housing;
a second actuator lever that is pivotal on a second lever axle proximate a second end of the actuator housing;
a first-direction stop latch having a first-stop pivot end attached pivotally to the first lever axle;
the first-direction stop latch having a first-stop buttress end extended pivotally to engage first sides of the bidirectional actuator buttresses one actuator buttress at a time;
a second-direction stop latch having a second-stop pivot end attached pivotally to the second lever axle;
the second-direction stop latch having a second-stop buttress end extended pivotally to engage second sides of the bidirectional actuator buttresses one actuator buttress at a time;
a first-direction actuation latch having a first-actuation pivot end attached pivotally to the first actuator lever at a first lever position that is outwardly from the first lever axle;
the first-direction actuation latch having a first-actuation buttress end extended pivotally from the first actuator lever to engage the bidirectional actuator buttresses one actuator buttress at a time;
a second-direction actuation latch having a second-actuation pivot end attached pivotally to the second actuator lever at a second lever position that is outwardly from the second lever axle;
the second-direction actuation latch having a second-actuation buttress end extended pivotally from the second actuator lever to engage the bidirectional actuator buttresses one actuator buttress at a time;
the first-direction stop latch facing the second-direction stop latch;
the first-direction actuator latch facing the second-direction actuator latch;
a first stop spring having push-expansion pressure applied intermediate the first-directional stop latch and the first-direction actuation latch for actuating the first-direction stop latch in a direction of the bidirectional actuator buttresses one actuator buttress at a time;
a first actuator spring having push-expansion pressure applied intermediate the first actuator lever and the first-direction actuation latch for actuating the first-direction actuator latch in a direction of the bidirectional actuator buttresses one actuator buttress at a time;
a second stop spring having push-expansion pressure applied intermediate the second-directional stop latch and the second-direction actuation latch for actuating the second-direction stop latch in a direction of the bidirectional actuator buttresses one actuator buttress at a time; and
a second actuator spring having push-expansion pressure applied intermediate the second actuator lever and the second-direction actuation latch for actuating the second-direction actuator latch in a direction of the bidirectional actuator buttresses one actuator buttress at a time.

4. The cable-splicing system of claim 3 wherein:
the first stop spring and the first actuator spring include a first wire ratchet spring having a first end attached to the first-direction stop latch and a second end attached to the first-direction actuation latch;
the first wire ratchet spring is routed through a first regulator bolt that is extended through a first regulator slot in a first side of the actuator housing;
the first regulator bolt has machine threading with which the first regulator bolt is screwed into a first regulator knob;
the first regulator slot is angled for positioning the first regulator bolt in order to position the first wire ratchet spring therein predeterminedly near the actuator buttresses for actuating ratchet engagement of the first-direction stop latch and the first-direction actuation latch and optionally by positioning the first stop spring predeterminedly removed from the actuator buttresses to prevent the ratchet engagement of the first-direction stop latch and the first-direction actuation latch with the actuator buttresses selectively;
the second stop spring and the second actuator spring include a second wire ratchet spring having a first end attached to the second-direction stop latch and a second end attached to the second-direction actuation latch;
the second wire ratchet spring is routed through a second regulator bolt that is extended through a second regulator slot in a second side of the actuator housing;
the second regulator bolt has machine threading with which the second regulator bolt is screwed into a second regulator knob; and
the second regulator slot is angled for positioning the second regulator bolt in order to position the second wire ratchet spring therein predeterminedly near the actuator buttresses for actuating ratchet engagement of the second-direction stop latch and the second-direction actuation latch and optionally by positioning the second stop spring predeterminedly removed from the actuator buttresses to prevent the ratchet engagement of the second-direction stop latch and the second-direction actuation latch with the actuator buttresses selectively.

5. The cable-splicing system of claim 3 wherein:
the jack rod is a polygonal tube and the actuator buttresses are walls of indentations in the outside periphery of the jack rod.

6. The cable-splicing system of claim 3 wherein:
the jack rod includes orthogonal sides and the actuator buttresses are walls of indentations in an orthogonal outside periphery of the jack rod.

7. The cable-splicing system of claim 3 wherein:
the jack rod is slidable in contact with slide walls and slide rollers on the bidirectional actuator.

8. A cable-splicing system comprising:
a bidirectional jack with a jack rod on which a plurality of bidirectional actuators are positioned with bidirectional actuation linearly on the jack rod;
the bidirectional actuators including a jacket collar;
the bidirectional actuators including a cable collar;
a plurality of bidirectional actuator buttresses in series linearly on an outside periphery of the jack rod;
the bidirectional actuators are single-lever actuators;
each of the single-lever actuators including a single-lever housing that is slidable linearly on the jack rod;
each of the single-lever actuators having a bidirectional lever that is pivotal on a single-lever axle on the single-lever housing;
a bidirectional stop latch that is pivotal on the single-lever axle;
the bidirectional stop latch having a first end that engages the bidirectional actuator buttresses one buttress at a time on a first side of the single-lever axle for stopping second-direction travel of the bidirectional actuator on the jack rod;
the bidirectional stop latch having a second end that engages the bidirectional actuator buttresses one buttress at a time on a second side of the single-lever axle for stopping first-direction travel of the bidirectional actuator on the jack rod;
a first latch on the first side of the bidirectional lever;
the first latch having a lever end attached pivotally to a first latch axle on the first side of the bidirectional lever;
the first latch having a buttress end that engages the bidirectional actuator buttresses one buttress at a time on the first side of the single-lever axle for actuating the bidirectional actuator in a first direction by pivoting the bidirectional lever oppositely in the second direction from the single-lever axle selectively;
a second latch on the second side of the bidirectional lever;
the second latch having a lever end attached pivotally to a second latch axle on the second side of the bidirectional lever;
the second latch having a buttress end that engages the bidirectional actuator buttresses one buttress at a time on the second side of the single-lever axle for actuating the bidirectional actuator in a second direction by pivoting the bidirectional lever oppositely in the first direction from the single-lever axle selectively;
a first stop spring having push-expansion pressure applied intermediate the first end of the bidirectional stop latch and the first latch;
a second stop spring having push-expansion pressure applied intermediate the second end of the bidirectional stop latch and the second latch;
a first latch spring having push-expansion pressure applied intermediate the first latch and a spring base that is outwardly from the first latch spring on the bidirectional lever;
a second latch spring having push-expansion pressure applied intermediate the second latch and the spring base that is outwardly from the second latch spring on the bidirectional lever;
the push-expansion pressure on the first latch spring and the push-expansion pressure on the second latch spring being adjustable with the spring base;
the push-expansion pressure on the first latch spring being increased and the push-expansion pressure on the second latch spring being decreased for actuation of the bidirectional actuator in the first direction; and
the push-expansion pressure on the second latch spring being increased and the push-expansion pressure on the first latch spring being decreased for actuation of the bidirectional actuator in the second direction.

9. The cable-splicing system of claim 8 wherein:
the jack rod is a polygonal tube and the actuator buttresses are walls of indentations in a side of the outside periphery of the jack rod.

10. The cable-splicing system of claim 8 wherein:
the jack rod includes orthogonal sides and the actuator buttresses are walls of indentations in a side of the outside periphery of the jack rod.

11. The cable-splicing system of claim 8 wherein:
the jack rod is slidable intermediate slide walls and slide rollers on the bidirectional actuator.

12. A cable-splicing system comprising:
a bidirectional jack with a jack rod on which bidirectional actuators are positioned with bidirectional actuation linearly on the jack rod;
the bidirectional actuators including a jacket collar;
the bidirectional actuators including a cable collar;
a plurality of bidirectional actuator buttresses in series linearly on an outside periphery of the jack rod;
the bidirectional actuators are single-lever actuators;
each of the single-lever actuators including a single-lever housing that is slidable linearly on the jack rod;
each of the single-lever actuators having a bidirectional lever that is pivotal on a lever axle on the single-lever housing;
a bidirectional stop latch that is pivotal on the single-lever axle;
the bidirectional stop latch having a first end that engages the bidirectional actuator buttresses one buttress at a time on a first side of the single-lever axle for stopping second-direction travel of the bidirectional actuator on the jack rod;
the bidirectional stop latch having a second end that engages the bidirectional actuator buttresses one buttress at a time on a second side of the single-lever axle for stopping first-direction travel of the bidirectional actuator on the jack rod;
a bidirectional actuator latch that is pivotal on a central actuator axle outwardly from the single-lever axle on the bidirectional lever;
the bidirectional actuator latch having a first buttress end that engages the bidirectional actuator buttresses one buttress at a time on the first side of the single-lever axle for actuating the bidirectional actuator in a first direction by pivoting the bidirectional lever oppositely in the second direction from the single-lever axle selectively;
the bidirectional actuator latch having a second buttress end that engages the bidirectional actuator buttresses one buttress at a time on the second side of the single-lever axle for actuating the bidirectional actuator in a second direction by pivoting the bidirectional lever oppositely in the first direction from the single-lever axle selectively;
a first stop spring having push-expansion pressure applied intermediate the first end of the bidirectional stop latch and the first buttress end of the bidirectional actuator latch;
a second stop spring having push-expansion pressure applied intermediate the second end of the bidirectional stop latch and the second buttress end of the bidirectional actuator latch;
a bidirectional actuation spring attached to a direction-control member extended from the lever axle;
the bidirectional actuation spring being bifurcated centrally from the direction-control member;
the direction-control member being pivotal in a first direction to apply push-expansion pressure of a first leg of the bidirectional actuation spring against the first end of the bidirectional stop latch and to remove the push-expansion pressure from the second leg of the bidirectional actuation spring for actuating the bidirectional actuator in the first direction from the single-lever axle by pivoting the bidirectional lever oppositely in the second direction from the single-lever axle; and
the direction-control member being pivotal in a second direction to apply push-expansion pressure of a second leg of the bidirectional actuation spring against the second end of the bidirectional stop latch and to remove the push-expansion pressure from the second leg of the bidirectional actuation spring for actuating the bidirectional actuator in the second direction from the single-lever axle by pivoting the bidirectional lever oppositely in the first direction from the single-lever axle.

13. The cable-splicing system of claim 12 wherein:
the direction-control member is attached to a direction-control knob having controlled pivotal positioning.

14. The cable-splicing system of claim 12 wherein:
the jack rod is a polygonal tube and the actuator buttresses are walls of indentations in a side of the outside periphery of the jack rod.

15. The cable-splicing system of claim 12 wherein:
the jack rod includes orthogonal sides and the actuator buttresses are walls of indentations in a side of an outside periphery of the jack rod.

16. The cable-splicing system of claim 12 wherein:
the jack rod is slidable intermediate slide walls and slide rollers on the bidirectional actuator.

17. A method comprising the following steps for using a cable-splicing system having a bidirectional jack with a bidirectional actuator that is actuated bidirectionally intermediate a first end and a second end of a jack rod; a jacket collar on the bidirectional actuator; and a cable collar attached to the jack rod at a desired position proximate the first end of the jack rod:
preparing a first joint end and a second joint end of a cable to be spliced;
attaching the cable collar to the cable at a cable-collar position on the cable that is a sufficient distance from the first joint end of the cable to allow temporary positioning of a cable jacket intermediate a cable splice and the cable-collar position;
attaching the jacket collar to a cable jacket;
positioning a first end of the cable jacket for receiving the first joint end of the cable into a circumferential internal periphery of the cable jacket;
actuating the bidirectional actuator in a first direction that is towards the cable-collar position for sliding the first joint end of the cable a sufficient distance through the cable jacket to expose the first joint end of the cable for being spliced to the second joint end of the cable;
splicing the first joint end to the second joint end of the cable with the cable splice;
actuating the bidirectional actuator in a second direction that is away from the cable-collar position for sliding the cable jacket from the temporary position to a splice-sealing position on the cable splice; and
removing the bidirectional jack by removing the jacket collar from the cable jacket and removing the cable collar from the first joint end of the cable.

18. A method comprising the following steps for using a cable-splicing system having a bidirectional jack with one or more bidirectional actuators that are actuated bidirectionally intermediate a first end and a second end of a jack rod; a first cable collar attached to the jack rod proximate a first end of the jack rod at a desired cable-collar position that is proximate a first joint end of a cable to be spliced; a jacket collar on a first bidirectional actuator of the one or more bidirectional actuators; and a second cable collar on a second bidirectional actuator of the one or more bidirectional actuators:
attaching the first cable collar to a first joint end of a cable to be spliced;
attaching the second cable collar to a second joint end of the cable;
actuating the second bidirectional actuator selectively for the cable to be held as desired intermediate the first cable collar and the second cable collar;
preparing the cable for splicing intermediate the first cable collar and the second cable collar;
attaching a cable jacket to the jacket collar;
positioning the first joint end of the cable for entry into the cable jacket;
actuating the first bidirectional actuator in a first direction towards the cable-collar position for sliding the first joint end of the cable into the cable jacket and for sliding the first joint end a sufficient distance through the cable jacket to place the cable jacket at a temporary position intermediate the first joint end of the cable and the cable-collar position;
splicing the first joint end to the second joint end of the cable with a cable splice;
actuating the first bidirectional actuator in a second direction away from the cable-collar position for sliding the cable jacket from the temporary position in a direction towards the second joint end to a splice-sealing position that covers the cable splice; and
removing the bidirectional jack by removing the jacket collar from the cable jacket, removing the first cable collar from the first joint end and removing the second cable collar from the second joint end of the cable.

19. The method of claim 18 wherein splicing the first joint end to the second joint end of the cable includes an additional step of adjusting tension of the cable on the cable splice intermediate the first joint end and the second joint end.

20. The method of claim 18 wherein splicing the first joint end to the second joint end of the cable includes an additional step of evaluation-testing of the splice by actuating the second bidirectional actuator in opposite directions selectively before removing the bidirectional jack.
